(19) United States
(12) Patent Application Publication
(10) Pub. No.: US 2021/0372812 A1
(43) Pub. Date: Dec. 2, 2021

(54) METHOD AND VEHICLE SYSTEM FOR OPTIMIZING PARKING SUGGESTIONS

(71) Applicant: Robert Bosch GmbH, Stuttgart (DE)

(72) Inventors: Thorben Schick, Hardegsen (DE); Dirk Fortmeier, Hildesheim (DE); Hartmut Loos, Hildesheim (DE)

(21) Appl. No.: 17/053,880

(22) PCT Filed: May 24, 2019
(86) PCT No.: PCT/EP2019/063452

§ 371 Date: Nov. 9, 2020

(30) Foreign Application Priority Data
Jun. 8, 2018 (DE) 10 2018 209 158.7

(51) Int. Cl. G01C 21/36; B60K 35/00; G08G 1/14

(52) U.S. Cl. CPC G01C 21/3685; B60K 35/00; B60K 2370/148; B60K 2370/166; B60K 2370/164; G08G 1/143

(57) ABSTRACT

A method for optimizing parking suggestions of at least one driver assistance system for at least one vehicle. At least one route to a destination is determined. Potential parking possibilities are determined for the at least one vehicle along the previously determined route. An acceptance of a parking suggestion from a selection of parking suggestions or a rejection of a parking suggestion is determined. Termination information is determined. A termination phase and a termination reason are analyzed and classified. The analysis results are taken into account for a selection of future parking suggestions. A vehicle system is also described.

### FIELD

The present invention relates to a method for optimizing parking suggestions of at least one driver assistance system for at least one vehicle, and to a system for carrying out such a method.

### BACKGROUND INFORMATION

Because of their many positive characteristics, driver assistance systems are a permanent component of most vehicles. They usually comprise technical devices for measuring parking spaces and for carrying out a parking maneuver. In order to technically facilitate driver assistance functions, the vehicles are equipped with a variety of sensors, optical systems, such as panoramic viewing systems or rear-view cameras, and evaluation units.

There are also systems and methods which send geographical data on detected parking spaces to a server where the information is made available for other vehicles to access. In the process, although a driver or a driver assistance system can detect the presence of a potential parking space for a vehicle, it cannot detect whether the potential parking space is also suitable for the respective vehicle.

Until now, no consideration has been given to factors which would exclude the use of a parking space for certain vehicles, such as driver preferences or special requirements based on vehicle dimensions or obstructions. Even when a parking space is rejected by the driver or a parking assistance system, the vehicle is led to a previously rejected parking space again on future trips. The route to a parking space is considerably complicated by unnecessary driving routes to different parking spaces which may be approached multiple times.

### SUMMARY

An object of the present invention is to provide a method and a vehicle system for providing parking suggestions which can take driver preferences into account.

This object may be achieved in accordance with example embodiments of the present invention. Advantageous developments of the present invention are described herein.

According to one aspect of the present invention, a method for optimizing parking suggestions of at least one driver assistance system for at least one vehicle is provided. In accordance with an example embodiment of the present invention, first of all, at least one route to a destination is determined in a step. In another step, potential parking options are determined for the at least one vehicle along the route previously determined. Then, acceptance or rejection of a parking suggestion from a selection of parking suggestions is established. If a rejection of the parking suggestion is established, termination information is determined. This is followed by an analysis and classification of a termination phase and a termination reason. Then, favored parking options and/or exclusion criteria are determined for parking options. The analysis results are taken into account when selecting future parking suggestions.

According to a further aspect of the present invention, a vehicle system is provided for executing the method according to the present invention. The vehicle system comprises at least one vehicle comprising a control unit and an infotainment system for facilitating an interaction between a driver and a parking assistance system and comprising a communication unit for establishing a data-conveying communication connection to at least one external server unit of the vehicle system.

All steps of the example method may be carried out by an internal control unit of the vehicle and may also be fully or partially carried out by an external server unit. For example, the method may determine a preferred, a fastest or a least congested route to a destination. The vehicle may be drivable autonomously, and alternatively or in addition may comprise a driver assistance system and/or a parking assistance system. Also, a variety of routes to the destination may be offered to the driver, the vehicle or to a driver assistance system for selection. Then, potential parking options in the vicinity of the selected route may be determined for the route. In addition, in parallel with this, parking options may also be suggested for the alternative routes. The parking options may be shown on a display using a map, for example. Alternatively, or in addition, the driver may be guided to the parking option by a voice navigation system of a digital assistant. In an autonomous vehicle, the selected route and the parking option may be selected by the autonomous vehicle or by an external server unit, and the parking maneuver can be carried out without the intervention of a possible driver or passenger.

In accordance with an example embodiment of the present invention, the method identifies the acceptance or rejection of a parking suggestion using various indicators. When the parking suggestion is rejected, various termination information is collected by the vehicle. To this end, the sensors and optical systems, in particular, of the vehicle are used to collect as much data as possible concerning the rejected parking space so as to then evaluate it and take it into account in future parking suggestions. Alternatively, or in addition, if a parking suggestion is accepted, various acceptance information may be collected. In this case as well, the sensors or optical systems of the vehicle may be used, for example, in order to collect as much data as possible concerning the preferred parking space. The collected information may be taken into account for future parking suggestions in order to provide parking suggestions to the driver, to the autonomous vehicle or to a parking assistance system using preferred features.

The data collected from the sensors and optical systems of the vehicle facilitate analysis and classification of a termination phase and a termination reason. For this purpose it is ascertained in which phase of the approach to the parking suggestion the driver, the autonomous vehicle or the parking assistance system terminated the parking attempt. For example, a differentiation may be made as to whether the parking suggestion had been approached at all, whether the vehicle passed by the suggested parking option or whether the vehicle terminated an entry into the suggested parking option. Possible termination reasons may include the impossibility of reaching the parking space, it is contaminated or blocked, or there is an unfavorable angle of entry, for example, as well as the parking space dimensions being too small or the ceiling height of the parking space being too low, for example inside of a parking garage.

After the evaluation and classification of the termination phase and the termination reason, the determined exclusion factors may be used to determine future parking suggestions in order to take the driver preferences or possible vehicle requirements into account.

The method according to the example embodiment of the present invention may facilitate improved parking space recommendations by taking into account information determined as to why a recommended parking space was not used.

The determined data may be used to individually structure and improve future recommendations for the specific driver and/or his vehicle, and to improve recommendations for drivers with similar parking space preferences or vehicles with similar characteristics, such as similar dimensions or wheelbases.

According to a further exemplary embodiment of the present invention, the acceptance of a parking suggestion is identified using acceptance indicators and the rejection of a parking suggestion is identified using rejection indicators. Indicators for accepting a parking space recommendation or acceptance of a suggested opening as a parking space may be when, for example, the engine is shut off at the suggested parking position or if a trajectory taken toward the suggested parking position is characteristic of a parking maneuver. Alternatively, an indicator for acceptance of a parking space recommendation may be deemed to be an active confirmation in systems designed for interaction with the driver, or an execution of an automated parking maneuver.

Furthermore, rejection of a parking suggestion may be identified using rejection indicators. Indicators for rejecting a suggested parking space may include the vehicle passing by the suggested parking option without parking there. Alternatively, in a selection method based on interaction with the driver, a rejection of the suggested parking option may be assumed when the space is actively rejected. When an automated parking assistant is being used, a suggested parking option may be directly rejected by the parking assistant. By providing a clear classification of when a suggested parking space is considered to have been accepted, it is then possible to clearly differentiate whether the parking space recommendation has met the driver's preferences or the vehicle requirements.

According to a further exemplary embodiment, data from video sensors, ultrasonic sensors, radar sensors, LIDAR sensors, odometry sensors and/or position sensors are used for the analysis and classification of a termination phase and a termination reason. The various sensors, for example video systems, ultrasonic sensors, radar sensors, LIDAR sensors, odometry sensors, GNSS sensors and the like, make it possible to generate and evaluate a multitude of relevant data. It is preferable here to rely on the technology of the driver assistance systems or parking assistants which are already being used in the vehicle. The various sensors may also be combined by way of sensor fusion. For example, to analyze the termination phase and the termination reason, data such as images or videos of the suggested parking space recorded by backup systems or panoramic viewing systems when passing by the space or during an automated parking maneuver are used.

Further data for analysis may be collected using the vehicle's sensor system. In addition, a parking maneuver trajectory and/or a rejection carried out manually by the driver from a parking assistant system may be used for the evaluation. Alternatively, or in addition, in the case of an active rejection by the driver, records of the interaction with the driver may be used, for example. In the selection of parking suggestions, the evaluation of the reason for the rejection and the determination as to the phase of the parking maneuver in which the driver or the vehicle ruled out the suggested parking option make it possible to avoid similar situations and to give a lower weighting to parking spaces with characteristics similar to those of the rejected parking option.

According to a further specific embodiment of the present invention, the method is carried out based on machine learning methods. Machine learning methods include deep neural networks, for example. These can be used to classify the termination phase and termination reason. The use of machine learning methods makes it possible to expand and adapt the method automatically. For example, this may facilitate automatic updating of the method and continuous adaptation to new situations such as construction sites in parking lots or to communication with a growing number of vehicles.

According to a further specific embodiment of the present invention, the acceptance or rejection of a parking suggestion is done by a parking assistance system or by a driver. Thus, it is possible that the driver actively selects a suggested parking space at his destination. In this way, the driver can express his personal preferences, such as the length of walks to the actual destination and preferences or dislikes of parking garages or the like. An active selection or rejection of a suggested parking option by a parking assistance system may be incorporated into the selection, in particular into the individual vehicle requirements, for example with regard to the vehicle's dimensions.

According to a further exemplary embodiment of the present invention, a rejection of a parking suggestion is carried out by the driver via a display, an infotainment system and/or voice-based via a digital assistant. In particular, if the sensors required for executing an automated parking maneuver are not present in the vehicle, or if there are other technical reasons why the automated method fails, a user interaction may replace substeps of the method instead of an automated procedure. Here, the interaction may proceed in various ways, for example based on a menu on a digital display unit or voice-based via a digital assistant. Moreover, if the driver wishes, additional information may be transmitted, for example as markings in the recorded image data.

According to a further embodiment of the present invention, the analysis and classification of a termination phase and a termination reason is carried out on a server unit external to the vehicle, or on a control unit internal to the vehicle. Preferably, the determined sensor and image data are compressed prior to their transfer to a server unit external to the vehicle for analysis. When the determined sensor and image data are analyzed in a control unit internal to the vehicle, the data may be processed without the intermediate step of transferring them to a server unit. On the other hand, outsourcing the analysis to a server unit external to the vehicle makes it possible to provide greater computing power.

According to a further exemplary embodiment of the present invention, the method generates similar parking space suggestions for similar vehicles and/or similar driver preferences. By determining similar preferences in the acceptance or rejection of parking spaces which have similar characteristics, the method is able to determine parallels in preferences. In the process, the method facilitates the generation of parking suggestions which gained approval from other drivers or parking assistance systems having similar acceptance or rejection behaviors with respect to similar parking suggestions. Alternatively, or in addition, during the selection process, the method makes it possible to assign a lower weighting to parking suggestions which had been rejected by drivers or parking assistance systems with similar preferences, or which have characteristics similar to parking suggestions which had already been rejected. Alternatively, or in addition, the method may generate similar parking suggestions for similar types of vehicles, for example.

According to a further specific embodiment of the present invention, the evaluated sensor and image data and the classification and analysis of the termination phase and the termination reason are made available for other vehicles to access on a server for purposes of determining parking space suggestions. For the purpose of selecting a parking space suggestion, this enables, on the one hand, other vehicles connected to the server unit to access the classified and analyzed termination phases and termination reasons of other vehicles. Furthermore, the vehicles receive information concerning characteristics and local conditions of possible parking space suggestions and may incorporate this information into their selection. Providing the analysis results also makes it possible to determine similar acceptance or rejection behaviors of different drivers or parking assistance systems of similar vehicles. By exchanging analysis data, estimates may be made concerning future acceptance or rejection behaviors, and thus more targeted suggestions for possible parking spaces may be provided by the method.

According to a further exemplary embodiment of the present invention, rejected parking spaces are ruled out or given less consideration for the vehicle and/or the driver in the future. In this case, the method may assign rejected parking spaces a lower weighting and only suggest them in exceptional cases, such as when there are no alternative parking options available. This prevents that, despite a clear rejection of the parking suggestion, the parking space, or others with similar characteristics, is suggested again, or even repeatedly, and then has to be rejected again. Alternatively, the rejected parking suggestion may be completely removed from the system or declared as being unsuitable, for example. By removing unsuitable parking options, the algorithms for identifying available parking spaces may be improved. Additionally, this results in options for personalization using additional learnable attributes and by collecting user preferences.

According to a further specific embodiment of the present invention, a temporary or permanent exclusion may be registered for rejected parking space suggestions. Temporary termination reasons may include current contamination, temporary blockages and size limitations due to other vehicles currently parked. A complete removal of parking options from the system is therefore not necessary since it is highly likely that the limitation only temporarily rules out parking the vehicle there. As soon as the vehicle itself or other vehicles connected to the server unit external to the vehicle established that the parking space has been opened up, the parking space may again be classified as being usable.

Below, preferred exemplary embodiments of the present invention are explained in more detail using very simplified schematic representations.

### BRIEF DESCRIPTION OF THE DRAWINGS

FIG. 1 shows a schematic vehicle system according to a specific embodiment according to the present invention.

FIG. 2 shows a schematic flow diagram for illustrating a method according to the present invention according to one specific embodiment.

### DETAILED DESCRIPTION OF EXAMPLE EMBODIMENTS

In the figures, identical design elements are respectively provided with the same reference numerals.

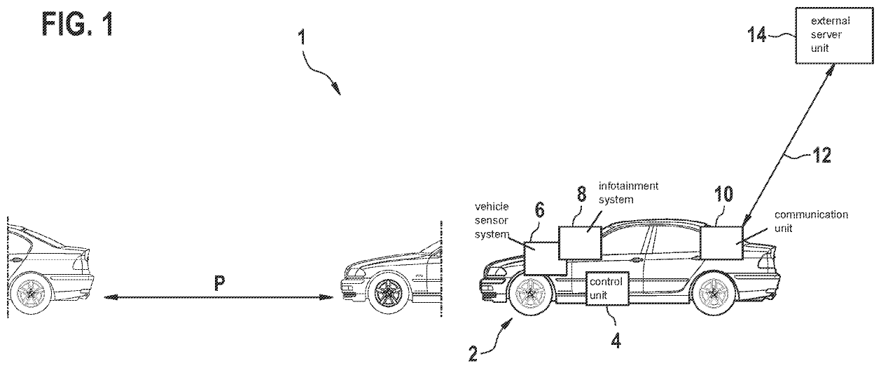

In FIG. 1, a vehicle system 1 according to one specific embodiment of the present invention is shown. The vehicle system 1 comprises at least one vehicle 2 which comprises a control unit 4 internal to the vehicle.

Control unit 4 is provided for evaluating a vehicle sensor system 6 and for operating an infotainment system 8. Vehicle sensor system 6 may comprise video sensors, radar sensors, ultrasonic sensors, LIDAR sensors, odometry sensors and/or position sensors, for example.

Furthermore, the at least one vehicle 2 comprises a communication unit 10 which control unit 4 may use for establishing a wireless communication connection 12 to an external server unit 14.

A parking assistance system may support the driver of vehicle 2 via infotainment system 8 in finding a parking space P. In this case, the parking assistance system may be provided via control unit 4 or via external server unit 14. In particular, the driver may be supported via a visual display or a voice-based system.

External server unit 14 or control unit 4 are designed to analyze the inputs and behavior of the driver via machine learning, thereby optimizing the parking assistance.

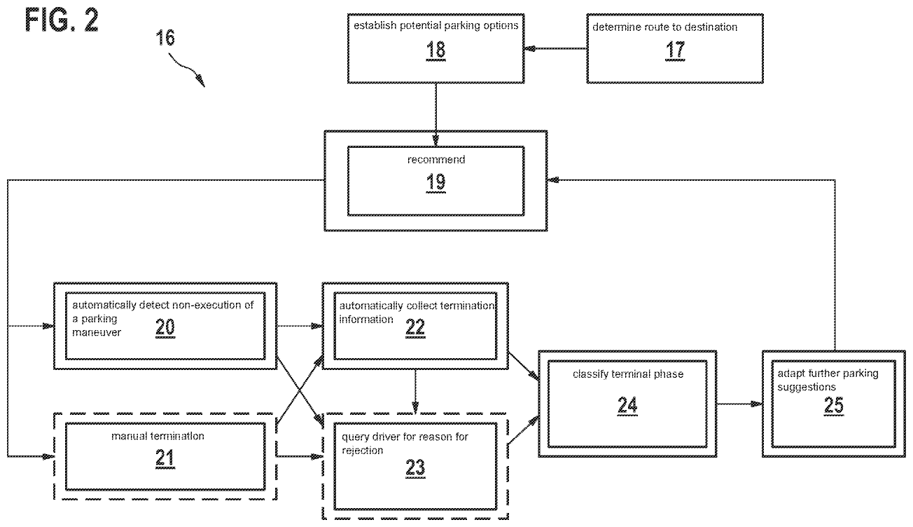

FIG. 2 shows a schematic flow diagram for illustrating a method 16 according to the present invention according to one specific embodiment. Method 16 facilitates the optimization of parking suggestions of at least one driver assistance system for the at least one vehicle 2.

In a step 17, at least one route to a destination is determined. Potential parking options P for the at least one vehicle 2 along the previously determined route are established 18. This may be done by control unit 4 which is internal to the vehicle or by server unit 14 which is external to the vehicle.

The parking options determined are recommended to the driver 19. Subsequently, it is determined whether the parking suggestion is accepted or rejected by the driver based on a selection of parking suggestions. This is preferably done in automated fashion in that control unit 4 or server unit 14 evaluate the behavior of the driver.

For example, the non-execution of a parking maneuver may be automatically detected 20 by the fact that a suggested parking space P was not approached by the driver.

Alternatively, a manual termination may be performed by the driver, or a parking space P suggestion may be manually rejected 21.

In the event that the parking suggestion is rejected 20, 21, termination information is collected 22, 23. In particular, the termination information may be collected automatically 22 by control unit 4 or by server unit 14. To this end, data from vehicle sensor system 6 may be analyzed along with a behavior of the driver. Alternatively, the driver may be queried 23 via infotainment system 8 as to a reason for a termination or a reason for a rejection. Steps 22 and 23 may also be carried out in parallel or in succession in this case.

The termination information is subsequently analyzed, and a termination phase is classified 24. In a further step 25, the termination information or the result of the analysis is used to adapt further parking suggestions to match the preferences and partialities of the driver and thereby to generate optimized parking suggestions. The analysis 24 and the utilization of the analysis 25 may be implemented by machine learning in particular, thereby improving the suggestions.

1-12. (canceled)

13. A method for optimizing parking suggestions of at least one vehicle assistance system for at least one vehicle, comprising the following steps:
determining at least one route to a destination;
determining potential parking options for the at least one vehicle along the determined route;
establishing an acceptance of a parking suggestion from a selection of parking suggestions or a rejection of the parking suggestion;
determining termination information;
analyzing and classifying a termination phase and a termination reason; and
using and taking into account results of the analyzing for a selection of future parking suggestions.

14. The method as recited in claim 13, wherein the acceptance of the parking suggestion is identified using acceptance indicators and the rejection of the parking suggestion is identified using rejection indicators.

15. The method as recited in claim 13, wherein data from video sensors, and/or ultrasonic sensors, and/or radar sensors, and/or LIDAR sensors, and/or odometry sensors and/or position sensors, are used for the analysis and classification of the termination phase and the termination reason.

16. The method as recited in claim 13, wherein the method is carried out based on machine learning methods.

17. The method as recited in claim 13, wherein the acceptance or the rejection of the parking suggestion is carried out by a parking assistance system or by a driver.

18. The method as recited in claim 13, wherein a rejection of a parking suggestion by a driver is carried out via a display, and/or via an infotainment system, and/or in voice-based fashion via a digital assistant.

19. The method as recited in claim 13, wherein the analysis and classification of the termination phase and the termination reason are carried out on a server unit external to the vehicle or on a control unit internal to the vehicle.

20. The method as recited in claim 13, wherein the method generates similar parking space suggestions for similar vehicles and/or similar driver preferences.

21. The method as recited in claim 13, wherein an analysis and classification of a termination phase and a termination reason of other vehicles are provided on the server unit external to the vehicle for parking space suggestions.

22. The method as recited in claim 13, wherein rejected parking spaces are excluded or given less consideration in the future for the vehicle and/or a driver.

23. The method as recited in claim 13, wherein a temporary or permanent exclusion is registered for rejected parking space suggestions.

24. A vehicle system for optimizing parking suggestions for at least one vehicle, the vehicle system configured to:
determine at least one route to a destination;
determine potential parking options for the at least one vehicle along the determined route;
establish an acceptance of a parking suggestion from a selection of parking suggestions or a rejection of the parking suggestion;
determine termination information;
analyze and classify a termination phase and a termination reason; and
use and take into account results of the analyzing for a selection of future parking suggestions.
